(19) United States
(12) Patent Application Publication
(10) Pub. No.: US 2013/0266412 A1
(43) Pub. Date: Oct. 10, 2013

(54) REMOVABLE MODULAR CARGO LOADING AND UNLOADING DEVICE FOR VEHICLES

(71) Applicant: JAMES YOUNG, Lake Alfred, FL (US)

(72) Inventor: JAMES YOUNG, Lake Alfred, FL (US)

(21) Appl. No.: 13/439,391

(22) Filed: Apr. 4, 2012

(51) Int. Cl. B60P 1/52

(52) U.S. Cl. 414/537

(57) ABSTRACT

A modular loading and unloading device for vehicles includes a main body having a plurality of surfaces defining a cavernous interior space, a plurality of roller caddies disposed within the cavernous space for positioning a pair of elongated rollers thereon. Each of the elongated rollers including a top portion protruding through openings disposed within the top surface of the main body in order to load and unload cargo within the bed of a truck or van. The device further including a plurality of connectors for joining multiple devices within the bed of a truck or van.

### TECHNICAL FIELD

The present invention relates generally to truck and cargo van systems, and more particularly to a lightweight removable modular loading device for allowing easy loading and unloading of cargo by lightweight vehicles.

### BACKGROUND

The statements in this section merely provide background information related to the present disclosure and may not constitute prior art.

Small businesses and individuals alike must sometimes transport bulky and/or palletized items from one location to another. Owing to the high price charged by commercial shippers who must purchase and maintain expensive specialized equipment, many small businesses attempt to use standard pickup trucks and/or vans to transport this cargo.

Although these vehicles are well suited well for transporting smaller items such as boxes and crates, they do not easily accommodate larger items such pallets and the like. To this end, when attempting to ship two palletized articles on a single load using a pickup truck, the user will commonly use a forklift to place the first pallet on the tailgate area and then push the pallet towards the cab with the forks of the forklift Next, the user will commonly repeat this process with the second palletized article using it to push the first pallet back, towards the cab.

During this process, the user must be extremely careful not to damage either of the palletized articles while they are making contact with each other, and must also make sure that the pallet itself does not damage the truck or van bed while sliding along its surface.

Upon reaching the destination, the user will typically retrieve the second palletized article from the tailgate area using another forklift in a conventional manner. However, traditional forklifts will not be able to reach the first pallet which is located closest to the cab area. As a result, the user must climb into the truck and manually push the first pallet towards the tailgate, or must use a chain to pull the first pallet towards the tailgate using the forklift. In either of these instances, injuries can result owing to improper rigging of the chain or physical harm to the user in the truck bed with the shifting cargo.

There are known devices directed towards moveable floors for vehicles. Many of these conventional devices utilize conveyor belts having a heavy frame and/or motorized components which must be permanently installed to a vehicle. As these devices typically raise the center of gravity of the load they carry, they are typically for use in specialized vehicles constructed for transporting heavy cargo loads.

Additionally, there are known bed sliders for use on smaller vehicles. These devices typically include rails which are mounted to the truck bed and slide out from the back of the tailgate in order to allow a user to retrieve small boxes and other lightweight articles from a side angle without having to climb into the truck bed.

While these devices fulfill their respective objectives, the above identified devices do not disclose a modular cargo loading and unloading device for vehicles performing the functions described herein.

Accordingly, it would be beneficial to provide a modular cargo loading and unloading device for vehicles which can work in unison with a forklift or other such device to transport palletized and other heavy goods on non-specialized vehicles.

### SUMMARY OF THE INVENTION

The present invention is directed to a modular loading and unloading device for vehicles. One embodiment of the present invention can include a main body having a plurality of surfaces defining a cavernous interior space, a plurality of roller caddies can be disposed within the cavernous space for positioning a pair of elongated rollers thereon. Each of the elongated rollers can include a top portion protruding through openings disposed within the top surface of the main body in order to load and unload cargo within the bed of a truck or van.

Another embodiment of the present invention can include connectors for securing multiple devices together within the bed of a truck or van, and can further include grooves for stacking a plurality of devices in a vertical fashion when not in use.

Yet another embodiment of the present invention can include a plurality of omnidirectional rollers for allowing cargo to be moved in any direction.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of a modular loading and unloading device for vehicles that is useful for understanding the inventive concepts disclosed herein.

FIG. 2 illustrates one embodiment of an elongated roller in accordance with one embodiment of the invention.

FIG. 3 is an exploded parts view of a modular loading and unloading device for vehicles in accordance with one embodiment of the invention.

FIG. 4 is a perspective view of a modular loading and unloading device for vehicles in accordance with another embodiment of the invention.

FIG. 5 illustrates one embodiment of the modular loading and unloading device for vehicles in operation, in accordance with one embodiment of the invention.

FIG. 6 is a perspective view of a modular loading and unloading device for vehicles in accordance with yet another embodiment of the invention.

FIG. 7 is a perspective view of a modular loading and unloading device for vehicles in accordance with an alternate embodiment of the invention.

FIG. 8 is a perspective view of a modular loading and unloading device for vehicles in accordance with another alternate embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

For purposes of this description, the terms “upper,” “bottom,” “right,” “left,” “front,” “vertical,” “horizontal,” and derivatives thereof shall relate to the invention as oriented in FIG. 1.

FIGS. 1-3 illustrate one embodiment of a modular loading and unloading device for vehicles 10 that is useful for understanding the inventive concepts disclosed herein. As shown, each device 10 can include a main body 11, for supporting a pair of pallet rollers 20.

The main body 11 can act as a frame for supporting the various components to be described herein. To this end, the main body can preferably be constructed from a sturdy material such as steel or aluminum, for example having a top surface 11a, a bottom surface 11b, a front surface 11c, a back surface 11d and a pair of opposing side surfaces 11e and 11f, all acting to form a cavernous interior space.

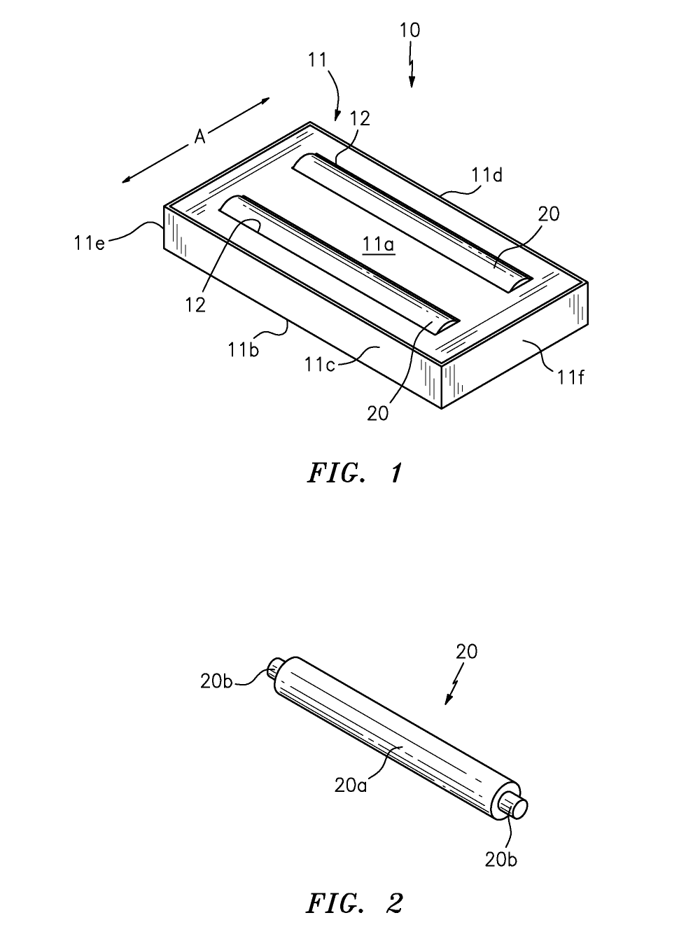

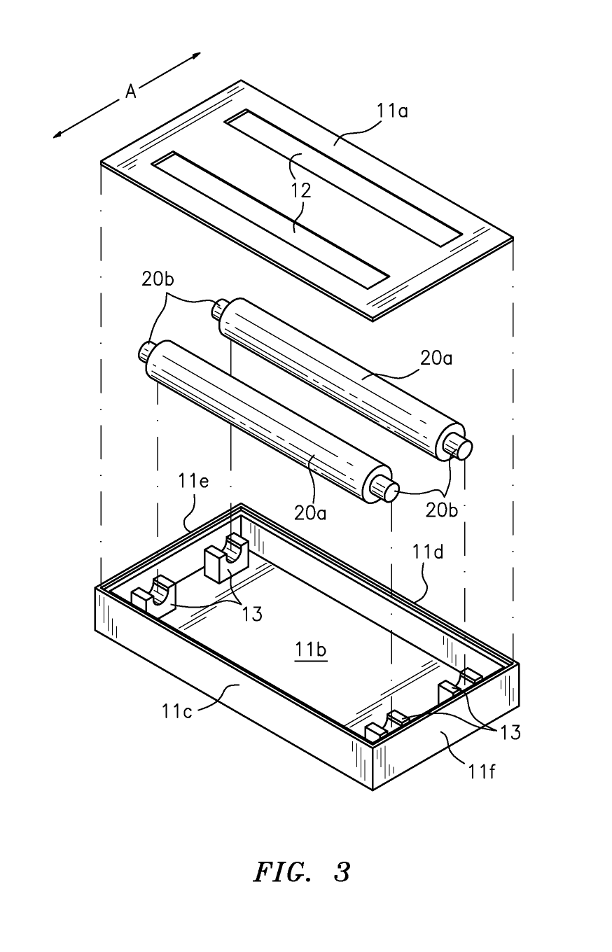

FIG. 2 illustrates one embodiment of an elongated roller 20 that includes a central tubular roller section 20a and a pair of roller stubs 20b positioned at each end. In one preferred embodiment, roller 20 can be constructed from a hardened material such as steel or aluminum, however other materials such as wood and plastic, for example, are also contemplated.

FIG. 3 illustrates an exploded parts view of the device 10 in accordance with one embodiment. As shown, the bottom surface of the main body 11 can include a plurality of roller caddies 13 positioned within the interior space. Each of the roller caddies can act as a cradle for receiving the roller stubs 20b of the elongated rollers, and positioning the same in a manner that allows the tubular roller sections 20a to rotate freely without making contact with the main body. When so positioned, each of the rollers can be aligned with, and protrude through the openings 12 of the top surface 11a, in order to move cargo forward and backward (see arrow A) within a truck bed.

Although illustrated as individual components, each of the roller caddies 13 can be molded into the construction of the main body in order to provide additional strength when in use.

As stated above, it is preferred that the present invention be capable of working within the bed of a cargo van and/or pickup truck 5 which has a typical width of four feet and a length of between four feet and eight feet. While the dimensions of the elements are not critical, in the preferred embodiment each device 10 can include an overall length (front surface 11c to back surface 11d) of approximately two feet, and a width (opposing side surface 11e to 11f) of approximately four feet. Additionally, it is also contemplated to provide devices having a reduced width (e.g., three feet) which can be utilized between the wheel wells 5a of most vehicles. Such a feature can allow multiple units to be positioned within the truck bed in order to work in unison for loading and unloading cargo. Finally, it is preferred that each device 10 include a height (bottom surface 11b to top surface 11a) of between two and six inches, in order to keep the center of gravity as low as possible when loaded with cargo.

Although described above as including specific dimensions and materials, this is for illustrative purposes only, as any number of shapes, dimensions and materials can be utilized. Moreover, it is also understood that alternate embodiments of the invention (not illustrated) can include as few as one roller or a plurality of rollers without deviating from the scope and spirit of the inventive concepts described herein.

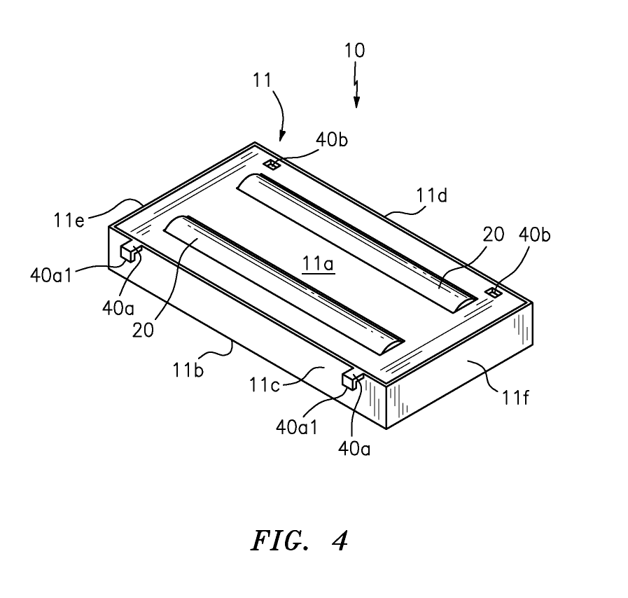

FIG. 4 illustrates another embodiment of the device 10 that further includes a plurality of connectors for joining multiple devices 10 together. In one preferred embodiment, each device can include a pair of male connectors 40a having a generally “L” shaped shaft protruding outward from the front surface 11c of the main body. The end 40a1 of the shaft can be bent downward in order to be inserted into a corresponding female connector/opening 40b that is located along the back portion of each device 10. As such, each of the connectors 40a and 40b can include a complementary shape and spacing for allowing the male connectors 40a of a first device 10 to be aligned with, and secured to the female connectors 40b of another device 10

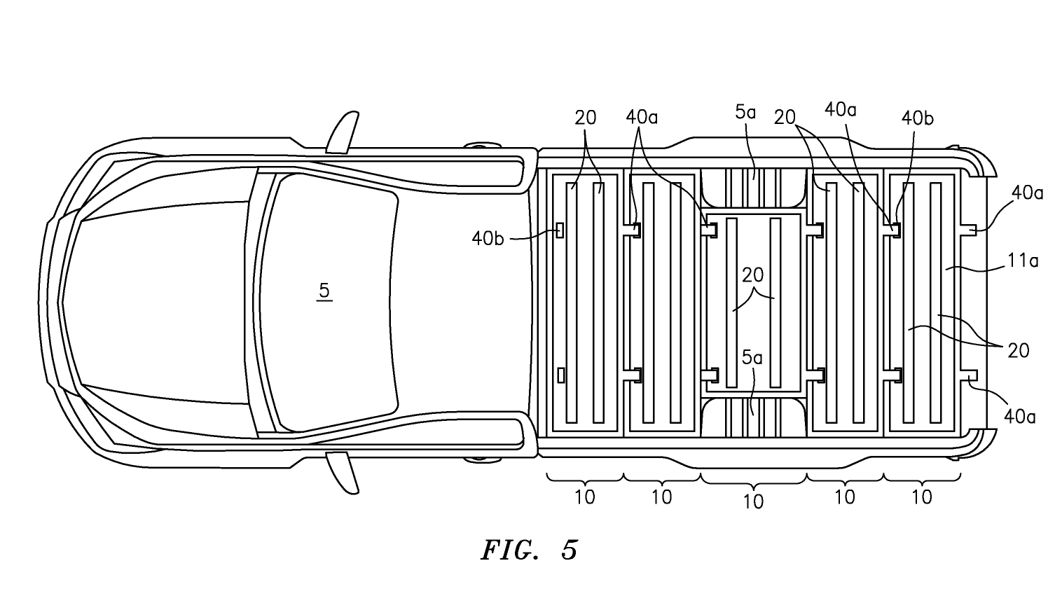

As shown in FIG. 5, multiple devices 10 can be installed in a modular fashion within the bed of a pickup truck/van 5 in order to allow cargo such as palletized goods to be loaded and unloaded from the rear of the vehicle.

Although described above as utilizing an L shaped bracket and opening, this is for illustrative purposes only. To this end, any number of known connection units capable of removably securing two objects together can be utilized herein. Several non-limiting examples include strips of hook and loop material (i.e. Velcro®) positioned on the front and back surfaces of the main body, as well as other known compression fittings, tethers and the like.

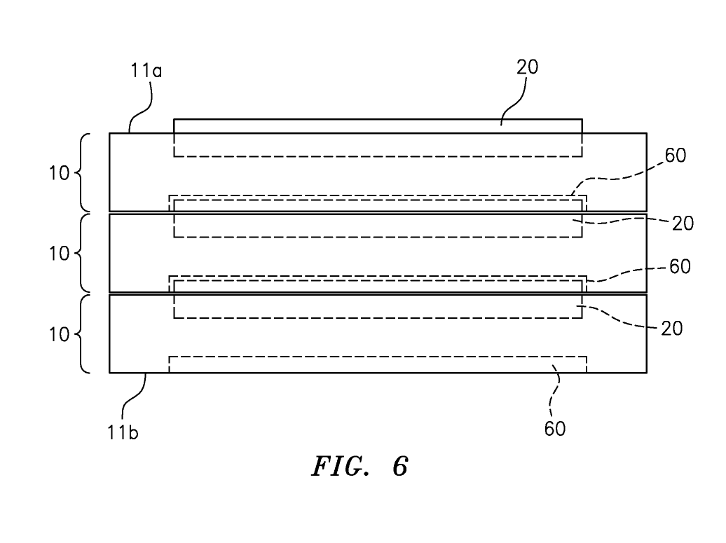

FIG. 6 illustrates another embodiment of the device 10 that further includes elongated grooves 60 along the bottom surface 1 lb of the main body. These grooves can correspond to the openings 12 and rollers 20 protruding from the top surface 11a, in order to allow multiple devices 10 to be stacked vertically when not in use. Such a feature can allow the devices to be stacked in a space saving manner when not in use.

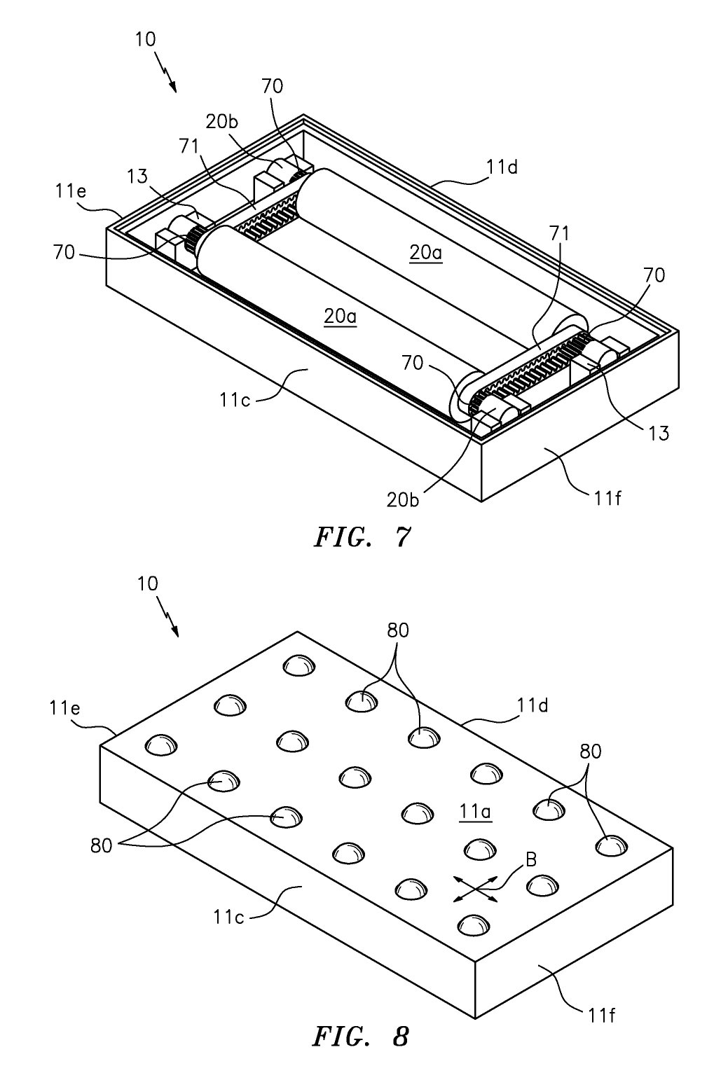

FIG. 7 illustrates an alternate embodiment of the device 10 that further includes a pulley 70 secured onto one or both ends 20b of each elongated roller 20 and connected to the adjacent roller via a belt 71. Such a feature can act to synchronize the rotation of each roller in order to assist with the loading and unloading of cargo. Belt and pulleys of the type illustrated are extremely well known in the art and can be constructed from any number of known materials such as steel or plastic, and the belt can be constructed from rubber, nylon or chain, for example. Although illustrated as utilizing a belt and pulley system, one of skill in the art will recognize that any number of other systems such as interlocking gears, for example, can also be utilized herein.

FIG. 8 illustrates another alternate embodiment of the device 10 wherein the elongated rollers 20 are replaced with a plurality of omnidirectional rollers/wheels 80 having a top portion protruding out of the top surface 11a of the main body. Such a feature can allow a user to move and rotate cargo in any direction (See arrow B) while utilizing the device 10. Omnidirectional rollers are extremely well known in the art, and include U.S. Pat. No. 3,874,491, the contents of which are incorporated herein by reference.

As described herein, one or more elements of the device 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individual elements such as the main body 11, and/or the cradles 13, including all sub components, for example, may be formed together as one continuous element, either through manufacturing processes, such as welding, casting, or molding, or through the use of a singular piece of material milled or machined with the aforementioned components forming identifiable sections thereof. Accordingly, in one embodiment, each of the main body and the cradles can be constructed from injection molded plastic having a height and dimension suitable for use within a conventional pickup truck bed and/or cargo van. Of course, other materials and construction methodologies are also contemplated. As such, it is preferred that the components of the device 10 be constructed from as lightweight yet sturdy materials as possible, in order to reduce the weight of the device itself, while remaining strong enough to function as needed.

Accordingly, by incorporating each of the above described features into a thin, lightweight and compact device, the modular loading and unloading device for vehicles 10 can be quickly and easily deployed within the bed of a truck or van during times of need, and then removed and stacked when not in use.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A modular loading and unloading device for vehicles, comprising:
a main body having a top surface, a bottom surface, a front surface, a back surface a pair of opposing side surfaces and a cavernous interior space;
a plurality of elongated openings disposed within the top surface of the main body;
a plurality of elongated rollers, each of said rollers including a central tubular roller section that is terminated on each end by a roller stub;
a plurality of roller cradles positioned within the cavernous interior space, each of said roller cradles being in communication with one of the roller stubs in order to allow the central tubular roller section to rotate without making contact with the main body,
said roller cradles being further configured to position each of the plurality of elongated rollers so that a portion of said rollers protrude through the openings.

2. The device of claim 1, further comprising:
a plurality of connectors configured to join multiple devices together within at least one of a conventional van and truck bed.

3. The device of claim 2, wherein said connectors include a plurality of male connectors having a generally L shaped shaft protruding outward from the front surface of the main body, and a plurality of corresponding female connectors disposed along a back side of the main body,
said male and female connectors being configured to removably secure the front surface of a first device to the back surface of a second device.

4. The device of claim 2, wherein said connectors include at least one of strips of hook and loop material and compression fittings secured to the front surface and the back surface of the main body.

5. The device of claim 1, wherein said main body includes a length of approximately two feet, and a width of approximately four feet, and said device is configured to be removably installed on at least one of a conventional van and truck bed.

6. The device of claim 1, wherein said main body includes a length of approximately two feet, and a width of approximately three feet, and said device is configured to be removably installed between a wheel well on at least one of a conventional van and truck bed.

7. The device of claim 1, wherein said main body includes a height of between two and six inches.

8. The device of claim 1, further comprising:
a plurality of elongated grooves disposed within the bottom surface of the main body,
each of said grooves having a location corresponding to a location of the openings in the top surface, and
each of said grooves being configured to receive the protruding portion of an elongated roller to allow a plurality of devices to be stacked in a vertical manner.

9. The device of claim 1, wherein each of the plurality of elongated rollers are connected via at least one of a belt and pulley system and a gear system.

10. The device of claim 1, wherein each of the main body, and the roller caddies are constructed from a single piece of injection molded plastic.

11. A modular loading and unloading device for vehicles, comprising:
a main body having a top surface, a bottom surface, a front surface, a back surface a pair of opposing side surfaces and a cavernous interior space;
a plurality of openings disposed within the top surface of the main body;
a plurality of omnidirectional rollers secured within the cavernous space, each of said rollers having an upper portion protruding through the openings;
a plurality of male connectors having a generally L shaped shaft protruding outward from the front surface of the main body, and a plurality of corresponding female connectors disposed along a back side of the main body, said male and female connectors being configured to removably secure the front surface of a first device to the back surface of a second device.

12. The device of claim 11, wherein said main body includes a length of approximately two feet, and a width of approximately four feet, and said device is configured to be removably installed on at least one of a conventional van and truck bed.

13. The device of claim 11, wherein said main body includes a length of approximately two feet, and a width of approximately three feet, and said device is configured to be removably installed between a wheel well on at least one of a conventional van and truck bed.

14. The device of claim 11, wherein said main body includes a height of between two and six inches.

15. The device of claim 11, further comprising:
a plurality of grooves disposed within the bottom surface of the main body,
each of said grooves being configured to receive the protruding portion of an omnidirectional roller to allow a plurality of devices to be stacked in a vertical manner.
